(19) United States
(12) Patent Application Publication
(10) Pub. No.: US 2004/0224722 A1
(43) Pub. Date: Nov. 11, 2004

(54) Wireless communication device having an integral laser pointer

(76) Inventor: Chun-Yu Lee, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/842,776

(22) Filed: May 10, 2004

(30) Foreign Application Priority Data
May 9, 2003 (TW) 92208549

(51) Int. Cl. F21K 2/00

(52) U.S. Cl. 455/556.1; 455/66.1

(57) ABSTRACT

A wireless communications device (200) having an integral laser pointer (220) includes a telephony circuitry (110), a ringing circuitry (130), a display circuitry (135), a laser pointer circuitry (120) for sending out the laser light; a switch (160) controls the operation mode of the telephony circuitry (110) and the laser pointer circuitry (120) at the same time; the telephony circuitry (110) and laser pointer circuitry (120) are couplable to the battery (140). For the configuration detailed above, wireless communications device (200) having an integral laser pointer (140) according to the present invention will not suffer from the calls or short messages.

### BACKGROUND OF THE INVENTION

1. Field of the Invention

The present invention generally relates to wireless communication devices, and more particularly to a wireless communication device having an integral laser pointer.

2. Prior Art

Useful electronic tools, such as laser pointers, are housed in pen-like housings, and are widely used in teaching, meeting and so on. Although such conventional laser pointers are easily carried, they are susceptible to being forgotten or lost. While wireless communication devices, such as cellular phones, have become virtually indispensable to certain persons. One attempt to combine the two things is disclosed in U.S. Pat. No. 6,327,484, issued to Siby V. Mathew (the '484 patent). In the '484 patent, a laser pointer is integrated with a cellular phone. The combination of the laser pointer and the cellular phone includes a telephony circuitry, a laser pointer circuitry, a battery and an antenna with a vacancy therein. The telephony circuitry and the laser pointer circuitry are coupled to the battery. The laser pointer is disposed in the vacancy of the antenna with the substantially coherent beam of visible light is emitted from an end portion of the antenna. One of the advantages is that a user may readily carry the laser pointer without being lost or forgotten. The combination also eliminates a need for a special recharging device for the batteries used in conventional laser pointers, since the integral laser pointer can be provided with power from the cellular phone battery.

However, such conventional laser pointers integrated with mobile phones will suffer from calls or messages whenever they are coming. Under this circumstance, teaching, meeting or presentation will be undesirablely disturbed. Though this can be avoid by customization actions, the custoization actions, but this process is troublesome, time-consuming, and easily being forgotten.

Accordingly, there is a need in the art for a laser pointer integrated with a wireless communication device not suffering from coming calls or short messages, when the laser pointer is in use.

### SUMMARY OF THE INVENTION

Accordingly, an object of the present invention is to provide a wireless communication device with an integral laser pointer not suffering from incoming calls or short messages.

To achieve the above mentioned objects, the present invention provides a wireless communication device having an integral laser pointer, such as a mobile phone, including a telephony circuitry, a laser pointer circuitry, a ringing circuitry, a display circuitry and a battery circuitry, wherein the telephony circuitry, the laser pointer circuitry, the ringing circuitry and the display circuitry are couplable together to the battery. A switch is set connecting the battery circuitry by one terminal, with the other terminal connecting with either the ringing circuitry and the display circuitry or the laser pointer circuitry.

### BRIEF DESCRIPTION OF THE DRAWINGS

FIG. 1 is a schematic view of a circuitry for a mobile phone having an integral laser pointer; and

FIG. 2 is a perspective view of the mobile phone having an integral laser pointer.

### DETAILED DESCRIPTION OF THE INVENTION

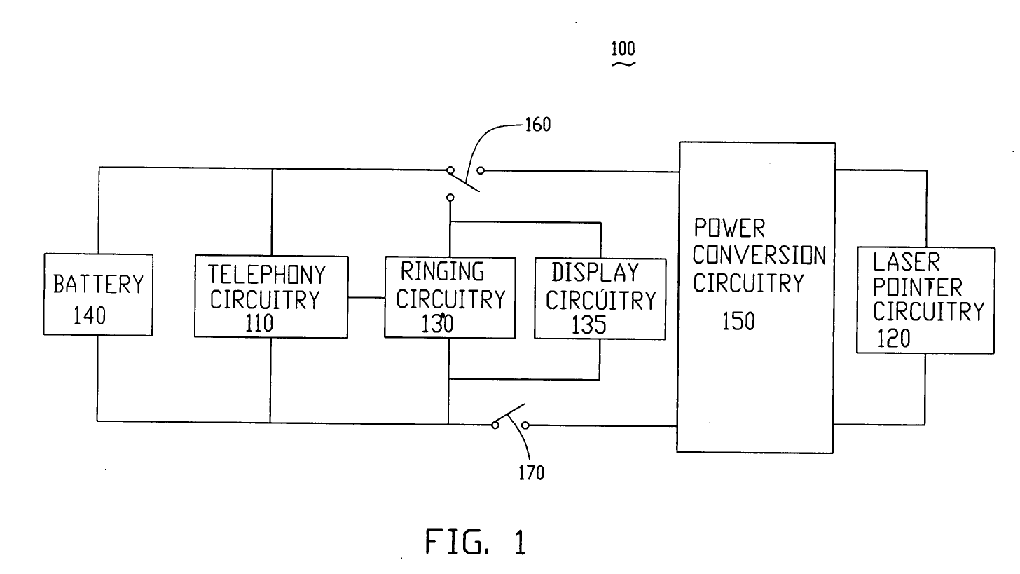

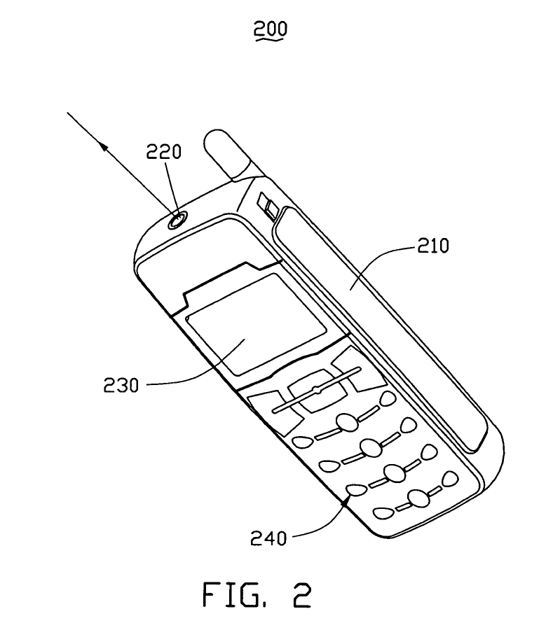

Referring to FIG. 2, a mobile phone 200 will be taken here as an example to disclose details of a wireless communication device having an integral laser pointer 220 according to a preferred embodiment of the present invention. The mobile phone 200 includes a housing 210, a telephony circuitry 110, a laser pointer circuitry 120, and other circuitries as shown in the FIG. 1 received therein, and a user interface with a display 230 and a keypad 240 thereon. The laser pointer 220 is exposed from a top wall of the mobile phone 200. The display 230 can be set in a power-saving mode by pressing a key on the keypad 240 when the laser pointer 220 is in use.

The keypad 240 includes a plurality of keys (not labeled), one of which is used to control a first switch 160 (shown in FIG. 1), and actuate the laser pointer circuitry 120; the key used to control the operation of the laser pointer circuitry 140 can be either dedicated to such operation, or can be served as a multi-function key to control other various functions of the mobile phone 200 based on a mode of operation with beam of light emitting from an aperture (not labeled) in the mobile phone 200 and illuminates a small region of a remote surface.

Referring now to FIG. 1, the mobile phone circuitry 100 comprises a telephone circuitry 110, a laser pointer circuitry 120, a ringing circuitry 130, a display circuitry 135, a battery 140, and a first switch 160 therein.

The telephone circuitry 110 is provided power by the battery 140. The laser pointer circuitry 120, the ringing circuitry 130 and the display circuitry 135 are selectively coupled to the battery 140 by the first switch 160. Power conversion circuitry 150 may also be included if the voltage rating of the battery 140 does not meet the input voltage rating of the laser pointer circuitry 120. Those skilled in the art are familiar with the use of power conversion circuitry to modify source of power to meet the requirements of specific electronic circuitry; the principles of the present invention are not limited to a specific power conversion circuitry, such circuit being selectable by those skilled in the art to meet the specific requirement of chosen laser pointer circuitry. Furthermore, the principles of the present invention are not limited to specific laser pointer circuitry.

The first switch 160 is controllable as a function of the ringing mode of operation of the ringing circuitry 130 and a displaying mode of the display circuitry 135. One terminal of the first switch 160 is electrically connected with the battery 140, and the other terminal can be connected with either the ringing circuitry 130 and the display circuitry 135 or the laser pointer circuitry 120. Generally the first switch 160 is connected with the ringing circuitry 130, so the mobile phone 100 can be operated as an ordinary phone. That is to say, when the mobile phone 100 is set in a ringing and displaying mode, the display 230 in the FIG. 2 will show some information and an incoming call or message will surely make the mobile phone 100 ringing. When the first switch 160 is set to connect with the laser pointer circuitry 120, the laser pointer 220 in the FIG. 2 can operated for teaching, meeting or taking presentations. During this time the ringing circuitry 130 is disabled to avoid suffering from incoming calls or messages. Thus even if the mobile phone 100 is set in the ringing mode, coming calls or coming messages will not ring which will not bother us by disturbing meeting we are in.

A second switch 170 may also be included if the laser pointer 220 is not necessary be turn on all the time. The second switch 170 can be set between the battery 140 turned off and the laser pointer 120, so when the first switch 160 is ruined off, users can turn the laser pointer 220 on or off through the second switch 170. Of course, the second switch 170 can also be set between the first switch 160 and the laser pointer circuitry 120.

For the widely use of the wireless communication, a laser pointer integrating in the wireless communication will not easily be forgotten, and will be easily shared with others just like a mobile phone. The integration of a laser pointer in a cellular telephone also eliminates the need for a special recharging device for the batteries used in conventional laser pointers, since the integral laser pointer can receive power from the mobile phone battery. When the laser pointer is enable, the ringing circuitry will be disabled, and at the same time, the display circuitry will also be disabled to save power.

It is believed that the present invention and its advantages will be understood from the foregoing description and it will be apparent that various changes may be made thereto without departing from the spirit and scope of the invention or sacrificing all of its material advantages, the examples hereinbefore described merely being preferred or exemplary embodiments of the invention.

We claim:

1. A wireless communication device having an integral laser pointer pivotally connected therewith, comprising:
a telephony circuitry;
a ringing circuitry for ringing when calls or messages coming;
a display circuitry comprises a display for showing some information;
a laser pointer circuitry comprises a laser pointer for producing laser light, used to send out the laser light;
a first switch controlling the operation mode of the telephony circuitry and the laser pointer circuitry at the same time, when the laser pointer is enable, the ringing circuitry and the display will be disable; and
a battery for providing power, wherein said telephony circuitry and said laser pointer circuitry being coupled to said battery.

2. The wireless communications device having an integral laser pointer of claim 1, wherein the display is set in a power-saving mode when the laser pointer is enabled.

3. The wireless communications device having an integral laser pointer of claim 1, further comprising a power conversion circuitry which is used to conversed the voltage to meet the laser pointer's input voltage.

4. The wireless communications device having an integral laser pointer of claim 1, further comprising a second switch which is set between the battery circuitry and the laser pointer circuitry for controlling the operation of the laser pointer.

5. The wireless communications device having an integral laser pointer of claim 4, further including a housing, said circuitries, said switches and said battery are set therein.

6. A wireless communication device comprising:
a built-in telephony circuitry and a built-in laser pointer circuitry;
a casing enclosing both said telephony circuitry and said laser pointer circuitry;
a laser pointer located on a first face of said casing and connected to said laser pointer circuitry; and
an antenna located on a second face of the casing and connected to said telephony circuitry.

7. The wireless communication device of claim 6, wherein the said first face and said second face are essentially same with each other.
